(19) United States
(12) Patent Application Publication
(10) Pub. No.: US 2002/0145978 A1
(43) Pub. Date: Oct. 10, 2002

(54) Mrp-based hybrid routing for mobile ad hoc networks

(76) Inventors: Stephen G. Batsell, Oak Ridge, TN (US); Inwhee Joe, Metuchen, NJ (US); Lawrence P. MacIntyre, Knoxville, TN (US); Michael Montgomery, Oakridge, TN (US)

Correspondence Address: McGuireWoods, Suite 1800, 1750 Tysons Boulevard, Tysons Corner, McLean, VA, 22102-4215, US

(21) Appl. No.: 09/825,878

(22) Filed: Apr. 5, 2001

(51) Int. Cl. H04L 1/00; H04J 1/16; H04J 3/14; G06F 11/00

(52) U.S. Cl. 370/238; 370/328

(57) ABSTRACT

In a mobile ad hoc network node first exchange their node sets of one-hop neighbors, thereby learning their sets of two-hop neighbors. A one-hop neighbor is a node in direct radio range of a source node. A two-hop neighbor node is one which, while beyond direct radio range of the source node, is in direct range of at least one of the source node's one-hop neighbor. Thereafter, each node selects a subset of its one-hop neighbor nodes, called the multi point relay (MPR) set, such that the subset can cover all the two-hop neighbors when forwarding broadcast traffic from that node. Outside the two-hop region, routes are discovered on a demand basis by flooding. However, flooding traffic is reduced because only the subset, instead of all one-hop neighbors, participates in forwarding.

This U.S. Government has a paid-up license in this invention and the right in limited circumstances to require the patent owner to license others on reasonable terms as provided for by the terms of contract No. DE-AC05-84OR21400 awarded by the U.S. Department of Energy.

### BACKGROUND OF THE INVENTION

1. Field of the Invention

The present invention generally relates to a routing protocol and, more particularly, to a routing protocol for mobile ad hoc networks.

2. Description of the Prior Art

Mobile wireless networks have become increasingly important for users of computing systems. There are currently two types of mobile wireless networks: infrastructure networks and ad hoc networks. Infrastructure networks are networks that include infrastructure such as base stations in cellular networks or access points in wireless local area networks. In contrast, ad hoc networks do not rely on any fixed infrastructure. They may be deployed during conferences or in rescue operations or military actions in enemy terrain, i.e., when mobile users need to communicate with each other in situations and places with no infrastructure and where rapid deployment of a network is required on a temporary basis. Mobile ad hoc networks are comprised of mobile nodes where each node comprises a router, a radio port and one or more host computers. To communicate with mobile nodes that are not within transmission range, a routing protocol is required.

In general, conventional routing protocols for packet-switched networks can be classified into distance vector or link state algorithms. In distance vector routing, each node periodically broadcasts to each of its neighbors the distances to all other nodes in the network, while in link state routing each node periodically broadcasts to all other nodes the state of its adjacent links. Since both types of algorithms are designed for static networks with wired links, they are not appropriate for mobile ad hoc networks with wireless links due to the high rate of topology change.

Recently, many routing protocols have been proposed for mobile ad hoc networks. For example, the Destination-Sequenced Distance Vector (DSDV) algorithm modifies the traditional distance vector algorithms to guarantee loop-freedom by using a sequence number for each route.

The Ad hoc On-demand Distance Vector (AODV) algorithm, set forth in Perkins et al., “AdHoc On Demand Distance-Vector (AODV) Routing”, Internet draft, draft-ietf-manet-aodv-02.txt, November 1998 (herein incorporated by reference) is an improvement of DSDV because it minimizes routing overhead by creating routes on a demand basis, as opposed to maintaining an entire list of routes for all nodes in the network as in DSDV. However, the problem with distance vector algorithms is that they are not suitable for supporting QoS (Quality of Service) based delivery, because they scale poorly in terms of communication complexity as the number of QoS metrics increases.

Another protocol is the so-called Dynamic Source Routing (DSR) algorithm which is an on-demand routing protocol that is based on the concept of source routing, where each packet carries the complete list of nodes to pass through in its header. Since intermediate nodes do not need to maintain routing information, routing overhead is reduced by eliminating periodic routing messages present in other protocols. However, as the network becomes larger, DSR suffers from a lack of scalability due to the nature of source routing.

Another routing protocol called TORA (Temporally Ordered Routing Algorithm) has been introduced for operating in a highly dynamic environment by localizing reaction to topological changes It is a distributed routing protocol based on the concept of link reversal. The problem is that TORA imposes significant overhead due to a large number of routing messages.

Optimized Link State Routing (OLSR) protocols of the HIPERLAN standard have also been developed. With this protocol, link state information can quantify the status of a link with various quality of service (QoS) metrics including bandwidth, delay, and probability of data loss. However, a major disadvantage of conventional link state algorithms is that each router is required to maintain complete topology information and to periodically broadcast the link state information to all other nodes in the network by flooding. Flooding is a technique where a node broadcasts a message and each node that receives the message broadcasts it in turn. This technique offers a good chance that a message will be delivered. However, this leads to a substantial performance degradation because of the larger overhead and excessive resource requirements.

Thus, there is a need in the art for a routing protocol for mobile ad hoc networks with a low overhead which can also provide quality of service (QoS) delivery.

### SUMMARY OF THE INVENTION

The present routing protocol uses the technique of MultiPoint Relaying (MPR) to compute routes through which to relay transmissions. In multipoint relaying, node routers first exchange their node sets of one-hop neighbors, thereby learning their sets of two-hop neighbors. A one-hop neighbor is a node in direct radio range of a source node. A two-hop neighbor node is one which, while beyond direct radio range of the source node, is in direct range of at least one of the source node's one-hop neighbor. Thereafter, each node selects a subset of its one-hop neighbor nodes, called the multi point relay (MPR) set, such that the subset can cover all the two- hop neighbors when forwarding broadcast traffic from that node. As a result, flooding traffic is reduced because only a subset, instead of all one-hop neighbors, participates in forwarding. In this process, each node builds a minimum spanning tree covering all of the neighbors in its two-hop region. For most applications over mobile ad hoc networks, it is expected that a major portion of communication will be done in the two-hop region. When a node needs a route to a destination in the two-hop region, it consults its routing table to find the route directly. Outside this region, routes are discovered on a demand basis. Since the nodes are mobile, the topology of the network changes frequently. When a node moves an upstream node in its one-hop region will recognize that the node is missing when it does not respond to a routing call and broadcast a message notifying all of its one-hop neighbors so that they can delete the node from their MPR sets. When a node moves to a new neighborhood, it likewise broadcasts a message which is received by all nodes within its range such that the nodes can update their lists of one-hop neighbors.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagram of a mobile ad hoc network topology showing one-hop and two-hop nodes and nodes outside the two-hop region;

FIG. 2A is a flow diagram showing the multipoint relay set-up and implementation according to the present invention;

FIG. 2B is a flow diagram showing the new neighbor routine;

FIG. 2C is a flow diagram showing the routine for creating an MPR set;

FIG. 2D is a flow diagram showing the routine for computing a reverse route;

FIG. 2E is a flow diagram showing the routine for receiving a route return;

FIG. 2F is a flow diagram showing the routine when receiving a route update;

FIG. 2G is a flow diagram showing the routine for receiving an MPR set from a neighboring node;

FIG. 2H is a flow diagram showing updating an MPR set;

FIG. 2I is a flow diagram showing the routine for managing a downed link;

FIG. 3 is a diagram of a mobile ad hoc network topology illustrating route maintenance for intermediate node movement;

FIG. 4 is a diagram of a mobile ad hoc network topology showing route maintenance for source node movement; and

FIG. 5 is a diagram of a mobile ad hoc network topology showing route maintenance by snooping.

### DETAILED DESCRIPTION OF A PREFERRED EMBODIMENT OF THE INVENTION

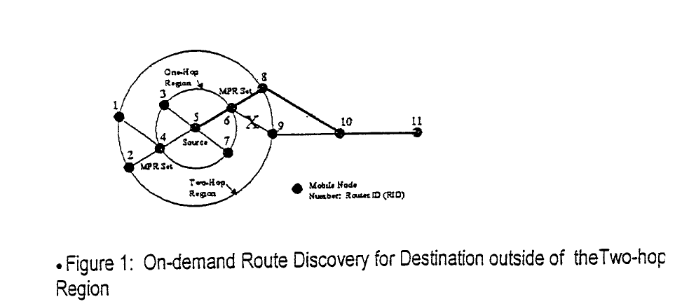

In order to illustrate the present invention, the concept of “hops” is introduced. Hops are viewed from the reference point of an individual node. As shown in FIG. 1, in a mobile ad hoc network, source node 5 sits in the middle of two concentric circular regions. This inner circuit is termed the one-hop region and the outer circle is termed the two-hop region. Mobile nodes 3, 4, 6, and 7 sit within node 5's one-hop region. That is, nodes within the one-hop region are within direct radio range of node 5 and therefore node 5 can communicate directly with any of these one-hop neighbors. Nodes 1, 2, 8, and 9 are located within node 5's two-hop region. These two-hop nodes are out of direct radio range of node 5 and therefore cannot be directly accessed by node 5. However, nodes in node 5's two-hop region are only one hop away their closest neighbors in the one-hop region. For example, nodes 6 and 7 are only one hop from nodes 8 and 9. Likewise, nodes 3 and 4 are only one hop from nodes 1 and 2. Thus, in order for node 5 to communicate with nodes in its two-hop region, the communication must be routed through an appropriate node in its one-hop region. In this same manner, node 10 is three hops from node 5 and node 12 is four hops from node 5.

To minimize flooding traffic, the present routing protocol uses the technique of MultiPoint Relaying (MPR). In multipoint relaying, routers first exchange their node sets of one-hop neighbors, thereby learning their sets of two-hop neighbors. For example, node 5 learns of its two-hop neighbors, node 8 and node 9, by exchanging one-hop information with node 6. Likewise, during the course of the exchange, node 6 learns of its two-hop neighbors 3 and 4 from node 5.

Thereafter, each node selects a subset of its one-hop neighbor nodes, called the multi point relay (MPR) set, such that the subset can cover all the two- hop neighbors when forwarding broadcast traffic from that router. As a result, flooding traffic is reduced because only a subset, instead of all one-hop neighbors, participates in forwarding. In this process, each router builds a minimum spanning tree covering all of the neighbors in its two-hop region. For most applications over mobile ad hoc networks, it is expected that a major portion of communication will be done in the two-hop region. When a node needs a route to a destination in the two-hop region, it consults its routing table to find the route directly. Outside this region, it discovers a route on a demand basis.

Outside the two hop region, route discovery is accomplished on a demand basis using the AODV procedure discussed above. However, unlike AODV, the present invention uses multipoint relaying to minimize the overhead of route discovery. Once the route is obtained, it is maintained in a cache as long as it is valid. Since mobile ad hoc networks are characterized by frequent changes in link connectivity due to node movement, the validity of routes is determined on-demand instead of through periodic hello messages.

Multicasting is desirable for supporting multiparty communications, because it provides an efficient way of delivering data from a sender to a group of receivers by sending a single copy of the data to all the receivers instead of a separate copy to each individual receiver. For multicasting in the two-hop region, a multicast tree can easily be formed using the MPR set. Since the present protocol is based on AODV for nodes outside the two-hop region, it can use the multicast features of AODV that are already developed. In fact, AODV is one of the few routing protocols that supports multicast for mobile ad hoc networks.

Following is described the basic operation of present routing protocol including MPR setup, route discovery, and route maintenance.

MPR Setup:

To implement efficient flooding over mobile ad hoc networks, each router selects its MPR set from its set of one-hop neighbors. In addition, each router creates a routing table for its two-hop region and also generates a minimum spanning tree rooted at that router.

When a mobile ad hoc network is first deployed, or when a router (node) joins an existing network, each router initializes itself by broadcasting its router identifier (called RID) and the network addresses of host computers attached to it. As a result, each node learns which neighbors are one hop away and records the information in its one-hop neighbor table.

Each router exchanges its one-hop neighbor information, thereby learning which neighbors are two hops away. This information regarding the two hop neighbors is stored. At this point, each router constructs its MPR set by selecting a subset of its one-hop neighbors which forward its broadcast traffic to the two-hop neighbors, minimizing the flooding traffic. In addition, each router builds a minimum spanning tree comprising of all the neighbors in the two-hop region and a routing table for its two-hop region. The routing table has the following fields for each host computer in the two-hop region: network address of the destination host, QoS metrics, RID of the next hop, and interface used at the source.

Each router advertises its MPR set by broadcasting to the one-hop neighbors. If a certain node is a member of the MPR set, it records the sender's address in the selector table of the MPR set so that it will forward flooding message from that sender.

Route Discovery

From the standpoint of each node, the network is divided into two regions by the two-hop boundary. If a destination node is located in the two-hop region, the source node looks in its routing table and computes a route to the destination on its own. Since much communication is expected to take place inside this region, the speed of route discovery is accelerated on the average due to the fast table lookup.

Outside the two-hop region, routes are discovered on a demand basis. When a source node wants to send a message to a destination outside the two-hop region and does not have a valid route in the route cache, it initiates a route discovery by broadcasting a route search (RSCH) packet to its neighbors. To minimize flooding traffic, the RSCH packet is forwarded by multipoint relaying until it reaches a node that has a route to the destination in its routing table or its route cache. Each node that forwards the RSCH packet creates a reverse route to the source in the route cache by adding as next hop the RID of the router from which the RSCH packet is received. This process is repeated until a node is discovered which has the destination node within its two-hop region.

Once the RSCH packet reaches a node with a route to the destination, the node generates a route return (RRET) packet. The RRET packet is sent back to the source using the information now stored in the route caches. Each node that participates in forwarding this RRET packet back to the source creates a forward route to the destination in its route cache. Since each node remembers only the next hop instead of the entire route, the present routing protocol is based on hop-by-hop routing (as opposed to source routing). Thereafter, the source node can transmit the its message to the destination node using the computed route. Each route in the route cache is associated with a route timer that will invalidate the entry if the route is not used before the timer expires.

Route Maintenance

In order to maintain routes, conventional routing protocols require each node to generate periodic hello messages. If a node fails to receive hello messages from a neighbor, the link to the neighbor is assumed to be down. In contrast to such proactive approaches, the present routing protocol operates on a demand basis to minimize the routing overhead. Therefore, a link failure cannot be detected until a data packet is actually sent over the link. The link failure is identified when there is no acknowledgment to a data packet at the link layer.

When a link goes down due to node movement, its upstream node notices the link failure on-demand with link-level detection and broadcasts a route update (RUPD) packet to its neighbor nodes after removing corresponding the entries in its routing table and route cache. The neighbors first check the RUPD packet to see if this upstream node belongs to their one-hop neighbor sets. If this is the case, each node updates its routing table, MPR set, and route cache in response to the RUPD packet. Since the routing table covers only the two-hop region, one-hop broadcasting from the upstream node is sufficient to update the routing tables that are affected by this link failure. For the route cache, an entry using this link will eventually be invalidated because it is not used again within its timeout. Finally, the upstream node obtains a new route to the destination using the route discovery procedure described in the previous section.

If the upstream node does not belong to any one-hop neighbor sets for nodes which received the RUPD packet, it means that this node is a new node in this neighborhood. This occurs when the source node is in motion and loses its connectivity with the next node along the route to the destination. In response to the RUPD packet from the source node, the neighbors insert the source node in their routing tables and one-hop neighbor tables, and then provide the source node with their one-hop neighbor information so that it can reinitialize its routing table, one-hop neighbor table, and MPR set. After that, the source node advertises its MPR set by broadcasting to its neighbors. Finally, the source node initiates the route discovery procedure to acquire a new route to the destination.

Mobile nodes may operate the network interface in promiscuous mode to update routes promptly in response to a change in the network topology. Promiscuous mode allows a node to snoop all packets that its network interface overhears. In particular, when a destination node moves within the transmission range of the source node, it can receive packets early by snooping their destination address, even though it is not a next-hop node along the route between source and destination. At the same time, it updates its neighbors' route tables by broadcasting an RUPD packet. In response to the RUPD packet, the neighbors update their routing tables and one-hop neighbor tables, and then send back their one-hop neighbor information so the destination node can reinitialize its local tables related to routing. After that, the destination node advertises its MPR set by broadcasting to its neighbors.

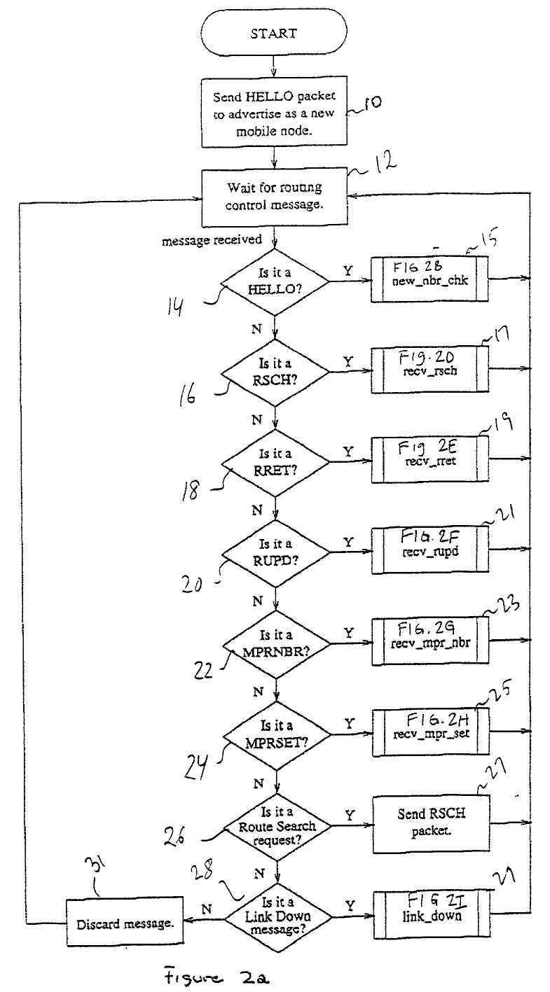

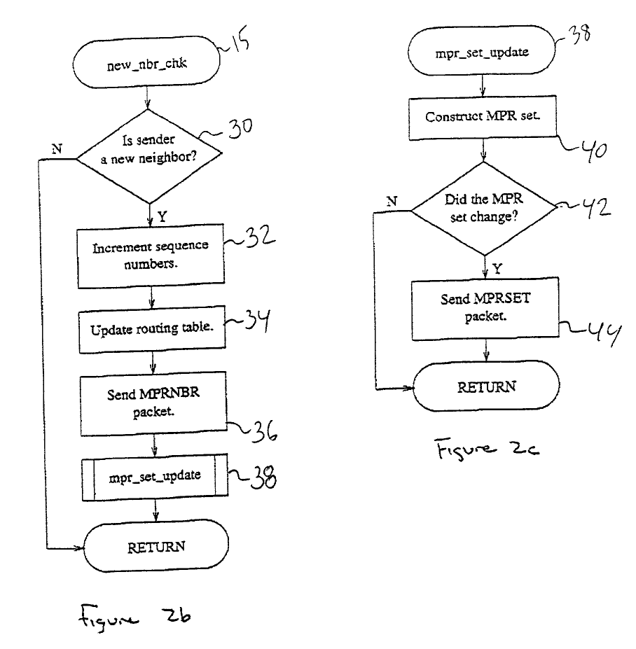

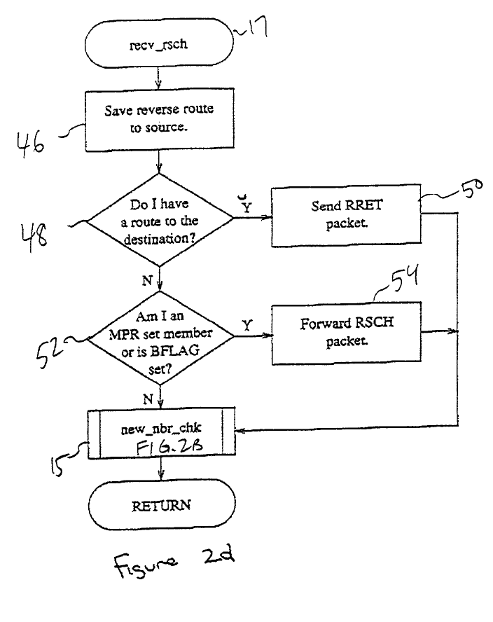

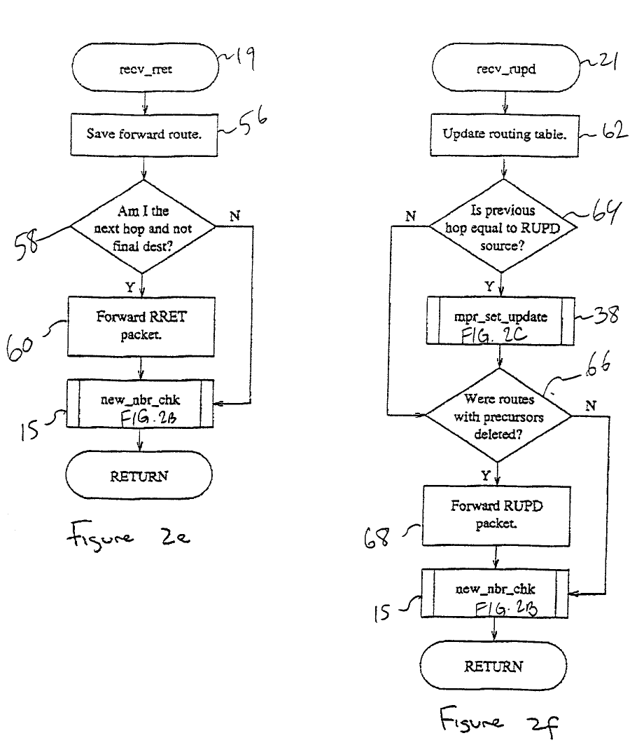

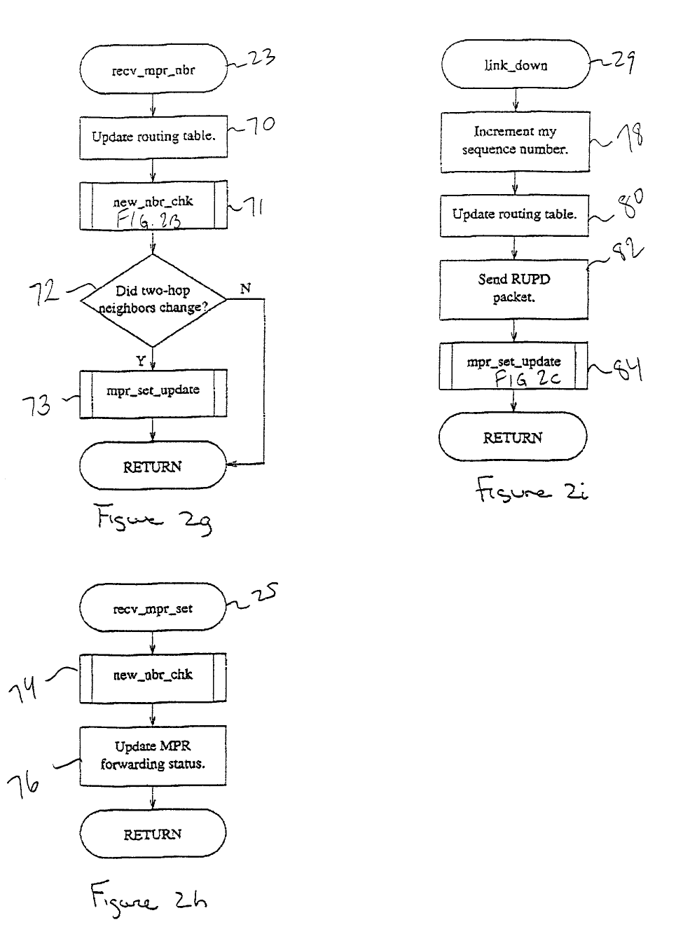

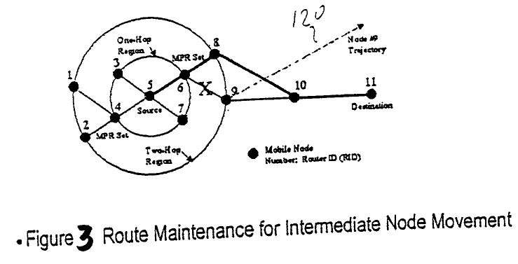

FIG. 2A is a flow diagram illustrating the operation of the invention. When a new node joins the ad hoc network (or an existing node moves to a new neighborhood) a HELLO packet is sent including the nodes route identification (RID) to advertise itself to all of its new one-hop neighbors 10. Thereafter, the node monitors a channel and waits for routing and control messages from its one-hop neighbors 12.

A received message can be any one of a plurality of messages such as a HELLO message from another node 14, a route search request RSCH packet 16, a route return RRET packet 18, route update RUPD packet 20, a multipoint relay neighbor MPRNBR packet 22, a multipoint relay set MPRSET packet 24, a route search request RSCH packet 26, or a link down message 28.

If the received message is a Hello message 14, the new_nbr_chk routine 15 is initiated as shown in FIG. 2B. In block 30 it is determined if the received HELLO message was sent from a new neighbor 30. If so, a route sequence number is updated 32, the routing table is updated and a new multi-point relay neighbor MPRNBR packet is sent 36 informing all of the node's one-hop neighbors of the new node. Thereafter, the multi-point relay set MPRSET is updated as shown in FIG. 2C. There, a new MPR set is constructed. Remember from above, the MPR set comprises a subset of one-hop neighbors that can cover all the two- hop neighbors when forwarding broadcast traffic from that particular node or router. If the MPR set has changed, MPRSET packet is transmitted to all of the router's one-hop neighbors.

Referring back to FIG. 2A, if a received routing control message is a route search RSCH packet, the recv_rsch procedure 17 shown in FIG. 2D is followed. At block 46, a reverse route is saved back to the node sending the RSCH. The node then looks at the destination address in the RSCH to determine if a route to that destination exists in its route table. If so, the node generates a route return (RRET) packet 50. The RRET packet is sent back to the source using the information now stored in the route caches. Each node that participates in forwarding this RRET packet back to the source creates a forward route to the destination in its route cache. Since each node remembers only the next hop instead of the entire route, the present routing protocol is based on hop-by-hop routing (as opposed to source routing). If a route to the destination does not exist in the receiving node, it is determined if the receiving node is an MPR set member or BFLAG is set at block 52. If so, the RSCH packet is forwarded to the next node in the route 54. If not, it is determined if the sending node is a new neighbor as illustrated in FIG. 2B. BFLAG indicates a flooding search and is used when a route search using MPRSET fails.

As shown in FIG. 2E, when a node receives an RRET packet, the recv_rret routine 19 is initiated and the forward route is saved 56. If the receiving node is not the final destination, but just the next hop 58, the RRET packet is forwarded to the next node 60. Again, a new neighbor check is then carried out as illustrated in FIG. 2B.

Referring to FIG. 2F, when a node receives a route update (RUPD) packet the recv_rupd routine 21 is initiated to handle a link has gone down due to node movement, and its upstream node has noticed the link failure. The receiving node immediately updates its routing table 62 to delete the missing node. It is then determined if a previous hop is equal to the RUPD source 64. If so, the MPR set is updated as shown in FIG. 2C. If not, it is determined if routes with precursors were deleted 66. If so, the RUPD packet is forwarded 68. That is, a node which sends (or forwards) a route search packet is recorded as a precursor node for that route. When a route return packet is received, it is forwarded to the precursor node. If a route with a precursor node is deleted, the route update packet is forwarded to the precursor nodes.

Referring to FIG. 2G, if a node receives a MPRNBR packet it indicates that a one-hop node is broadcasting that it has detected a new neighbor. In this case the recv_mpr_nbr routine 23 is executed and the receiving nodes routing table is updated 70 and a new neighbor check is initiated 71 as shown in FIG. 2B. Thereafter it is determined if, based on this new addition, if the receiving nodes two-hop neighbors have changed at block 72. If so, the MPR set is updated 73 as shown in FIG. 2C.

As shown in FIG. 2H, if a MPRSET packet is received the recv_mpr set routine 25 executes and a new neighbor check 74 is initiated as shown in FIG. 2B, and the MPR forwarding status is updated 76. The MPRSET packet indicates that the node is included in the sending nodes MPR set.

Referring back to FIG. 2A, when a source node wants to send a message to a destination outside the two-hop region and does not have a valid route in the route cache, it initiates a route discovery by broadcasting a route search (RSCH) packet 27 to its neighbors 26. To minimize flooding traffic, the RSCH packet is forwarded by multipoint relaying until it reaches a node that has a route to the destination in its routing table or its route cache. Each node that forwards the RSCH packet creates a reverse route to the source in the route cache by adding as next hop the RID of the router from which the RSCH packet is received as shown in FIG. 2D.

Referring to FIG. 2I, if a node receives a link down message the link_down routine 29 is initiated. The receiving node increments its sequence number 78 and thereafter updates its routing table to delete the downed link 80. The receiving node then transmits an RUPD packet to its neighbor nodes after removing corresponding the entries in its routing table and route cache. The receiving nodes MPR set is then updated 84 as shown in FIG. 2C. As noted above, node has a route timer that will invalidate the entry if the route is not used before the timer expires. If the entry is too old, it is discarded 31.

Below three examples are presented to show how the routing protocol works in typical scenarios.

### EXAMPLE 1

Consider a mobile ad hoc network consisting of eleven mobile nodes, as shown in FIG. 1. The mobile node is depicted as a small circle, and comprises a router, a wireless interface, and one or more host computers. Each node is assigned a router identifier (RID). Suppose that node 5 is a source node. There are two circles drawn around it: a smaller one for its one-hop region and a larger one for its two-hop region. To minimize flooding traffic for on-demand route discovery, nodes 4 and 6 are selected as the MPR set of the source node among its one-hop neighbors (nodes 3, 4, 6 and 7) so that all the two-hop neighbors (nodes 1, 2, 8 and 9) can be covered with the minimum amount of forwarding.

If a destination node is located in the two hop region, the source node looks in its routing table and directly obtains a route to the destination. Outside the two-hop region, it discovers a route on a demand basis using MPR flooding. For example, as shown in FIG. 1, if node 11 is the destination node, the source node 5 propagates an RSCH packet through MPR flooding in order to find a route to the destination. When the RSCH packet reaches node 9, node 9 can reply back with an RRET packet to the source node after consulting its routing table, because the destination node 11 is in the two-hop region of node 9. In this process, since nodes 3 and 7 are not members of the MPR set, they do not participate in forwarding, thereby reducing the flooding traffic. The thick lines between source and destination represent the route found using this on-demand route discovery procedure.

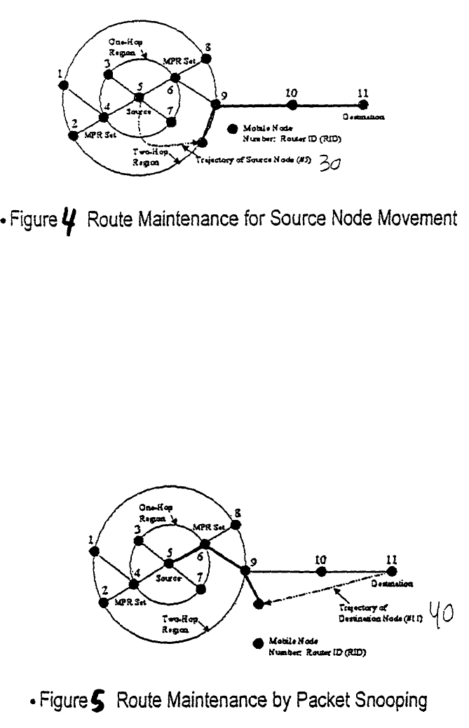

The present routing protocol maintains routes by detecting a link failure only when there is no acknowledgment to a data packet at the link layer. As an example, suppose that node 9 moves along the trajectory 120 as shown in FIG. 4. First, node 6, the upstream node of node 9, detects a link failure (designated by the “X”) between node 6 and node 9 when there is no acknowledgment in response to the data packet, because node 9 has moved out of its reception range. Then, node 6 updates its routing table and route cache, and it broadcasts an RUPD packet to its neighbor nodes so that they can also update their tables accordingly. After that, in order to acquire a new route to the destination, node 6 initiates the route discovery procedure by sending an RSCH packet to its neighbor nodes. When node 8 receives the RSCH packet, it can obtain a route to the destination by looking in its routing table, because the destination node 11 is in the two-hop region of node 8.

### EXAMPLE 2

Referring to FIG. 5, suppose that the source node 5 moves along, the trajectory 30. Node 5 detects a link failure to node 6 when there is no acknowledgment to a data packet sent over the link from the source. At this point, node 5 broadcasts an RUPD packet to its neighbor nodes as an upstream node. Since it is new in this neighborhood, the neighbor nodes register it in their tables as a new entry, and node 5 reinitializes its data structures including its routing table, route cache, and MPR set. After that, node 5 performs the route discovery procedure by sending an RSCH packet to its neighbors to acquire a new route to the destination. When the RSCH packet reaches node 9, it can obtain a route to the destination by looking in its routing table, because the destination node 11 is in the two-hop region of node 9.

### EXAMPLE 3

Referring to, an example is shown of the present protocol operating in promiscuous mode to maintain routes dynamically in response to a change in network topology. Suppose that the destination node 11 moves closer to the source node 5 as by trajectory 40. Even though node 11 is not a next-hop node of node 9 on the original route between source and destination, it receives packets directly from node 9 by “snooping” their destination address. At this point, node 11 broadcasts an RUPD packet to its neighbor nodes to update the route between node 5 and node 11. Since node 11 is new in this neighborhood, the neighbors register it in their tables as a new entry, and node 11 reinitializes its data structures including its routing table, route cache, and MPR set. After that, packets are sent from node 9 straight to the destination node 11 along the new route instead of relying on packet snooping.

While the invention has been described in terms of a single preferred embodiment, those skilled in the art will recognize that the invention can be practiced with modification within the spirit and scope of the appended claims.

We claim:

1. A routing protocol for mobile networks comprising a plurality of mobile nodes, comprising the steps of:
assigning each of a plurality of mobile nodes an identifier (ID);
each of said nodes storing a list of said identifiers of neighboring nodes in a one-hop region to create a one-hop neighbor list;
exchanging said one-hop neighbor list with one-hop neighbors;
creating a two-hop neighbor list from said exchanged one-hop neighbor lists;
selecting a subset of said one-hop neighbors, such that the subset can directly compute a route to all two-hop neighbors when forwarding broadcast traffic;
when forwarding broadcast traffic to a destination node beyond said two-hop neighbors of a source node:
forwarding a search request packet to said one hop neighbors until said destination node is present in said two-hop neighbor list;
storing a reverse path tracking a path of said request packet;
forwarding a route return packet via said reverse path to said source node to compute a path to said destination node.

2. A routing protocol for mobile networks as recited in claim 1 wherein when a node moves to a new neighborhood one of said one-hop neighbors will recognize a link failure and notify its one-hop neighbors to update their respective one-hop neighbor lists.

3. A routing protocol for mobile networks as recited in claim 1 wherein when a node monitors overheard packets for its own destination address to receive said overheard packets early.

4. A method of routing traffic packets through a mobile network comprising a plurality of mobile nodes, comprising the steps of:
each node creating a one-hop node list, where said one-hop node list comprises all other nodes within direct radio range;
exchanging said one-hop node list with each of said other nodes on said one-hop node list to create a two-hop node list;
selecting a subset of nodes on said one-hop list, such that the subset provides a path to all nodes on said two-hop node list;
computing a route between a source node and a destination node directly from said source node's one-hop neighbor list and said two-hop neighbor list when said destination node is within two-hops of said source node; and
said source node flooding only said subset nodes when searching for a route to a destination node beyond two-hops of said source node.

5. A method of routing traffic packets through a mobile network comprising a plurality of mobile nodes, comprising the steps of:
assigning each of a plurality of mobile nodes an identifier (ID);
each of said nodes storing a list of said identifiers of neighboring nodes in a one-hop region to create a one-hop neighbor list;
exchanging said one-hop neighbor list with one-hop neighbors;
creating a two-hop neighbor list from said exchanged one-hop neighbor lists; and
selecting a subset of said one-hop neighbors, such that the subset can directly compute a route to all two-hop neighbors when forwarding broadcast traffic.

6. A method of routing traffic packets through a mobile network as recited in claim 5 further comprising the step of discovering outside of said two-hop region by flooding.
